(19) United States
(12) Patent Application Publication
(10) Pub. No.: US 2022/0412530 A1
(43) Pub. Date: Dec. 29, 2022

(54) METHOD FOR CONTROLLING A LIGHTING DEVICE SUITABLE FOR EMITTING TWO PIXELATED LIGHT BEAMS WITH DIFFERENT RESOLUTIONS

(71) Applicant: VALEO VISION, Bobigny (FR)

(72) Inventor: Mickael MIMOUN, Bobigny (FR)

(73) Assignee: VALEO VISION, Bobigny (FR)

(21) Appl. No.: 17/630,293

(22) PCT Filed: Jul. 20, 2020
(86) PCT No.: PCT/EP2020/070491

§ 371 Date: Aug. 29, 2022

(30) Foreign Application Priority Data
Jul. 31, 2019 (FR) FR1908777

(51) Int. Cl. F21S 41/65; F21S 41/683; F21S 41/153

(52) U.S. Cl. CPC F21S 41/65; F21S 41/683; F21S 41/153

(57) ABSTRACT

The invention relates to a method for controlling a lighting device for a motor vehicle comprising at least first and second light modules arranged to emit, respectively, first and second pixelated light beams in first and second predetermined emission zones which are associated with them, the resolution of the first pixelated light beam being greater than the resolution of the second pixelated light beam and the first and second predetermined emission zones being adjacent, the method includes detecting the presence of a target object in a given zone among the first and second predetermined emission zones and forming a dark zone in the pixelated light beam associated with the given zone, by extinction or attenuation of at least one pixel of the pixelated light beam, located at the level of the target object.

### CROSS-REFERENCE TO RELATED APPLICATIONS

This application is filed under 35 U.S.C. § 371 U.S. National Phase of International Application No. PCT/EP2020/070491 filed Jul. 20, 2020 (published as WO2021018657), which claims priority benefit to French application No. 1908777 filed on Jul. 31, 2019, the disclosures of which are herein incorporated by reference in their entirety.

### TECHNICAL FIELD

The invention relates to the field of lighting for motor vehicles. More specifically, the invention relates to the field of lighting for motor vehicles by means of two pixelated beams with different resolutions.

### BACKGROUND OF THE INVENTION

In the field of lighting for motor vehicles, light modules are known that comprise enough selectively activatable light sources, associated with an optical device, to allow pixelated lighting functions to be implemented, for example, containing at least 500 pixels, with each pixel being formed by an elementary light beam emitted by one of the light sources. This type of module allows the host vehicle to implement, for example, anti-dazzle high beam functions, in which some pixels of the high beam are turned off or attenuated in order to form a dark zone at the level of a target object, such as a followed or passing target vehicle, so as to avoid dazzling them.

### BRIEF SUMMARY OF THE INVENTION

The pixelated light beam, called high-resolution light beam, emitted by this type of module is generally emitted in a restricted and dedicated emission zone. Indeed, the cost of this type of module is particularly high, and would become prohibitive if the high-resolution pixelated light beam had to be emitted over the whole road. Furthermore, there is generally no requirement for a high-resolution beam over the whole road, but only over a specific zone such as, for example, a central zone of the road, in which a target object present on the road is very far from the host vehicle and requires fine resolution in order for the dark zone to contain only the target object and for the pixels that remain activated to illuminate as much of the road as possible. On the contrary, the requirements with respect to resolution in emission zones other than that of the high-resolution beam are reduced. For example, for passing or followed target vehicles that are close to the host vehicle, a coarser resolution than that of the pixelated high-resolution beam is sufficient.

It is to this end that a hybrid lighting device has been devised that comprises light modules suitable for respectively emitting high-resolution and low-resolution beams in adjacent emission zones and together implementing an anti-dazzle high beam function. Within this context, the problem nevertheless arises of the perception, by the driver of the host vehicle, of the transition of a dark zone at the level of the target object that must not be dazzled from the high-resolution pixelated beam toward the low-resolution pixelated beam, and vice versa. Indeed, when a target object moves from the zone of the high-resolution beam toward the zone of the low-resolution beam, the sudden extinguishing of one or more pixels of the low-resolution beam is observed, whereas the dark zone formed in the high-resolution beam is still present. This sudden extinguishing in order to form a dark zone that is much larger than that which is already present in the high-resolution beam can hinder the driver of the host vehicle, and therefore represents a safety issue.

Thus, the aim of the invention is to address this problem by proposing a method for controlling a hybrid lighting device that does not or only slightly hinders the driver of the host vehicle during the transition of a target object from the zone of the high-resolution beam toward the zone of the low-resolution beam, and vice versa.

To this end, the aim of the invention is a method for controlling a lighting device for a motor vehicle comprising at least first and second light modules arranged to respectively emit first and second pixelated light beams in first and second predetermined emission zones that are associated with them, the resolution of the first pixelated light beam being greater than the resolution of the second pixelated light beam and the first and second predetermined emission zones being adjacent, the method comprising the following steps:

a. detecting the presence of a target object in a given zone from among the first and second predetermined emission zones;

b. forming a dark zone in the pixelated light beam associated with said given zone, by extinguishing or attenuating at least one pixel of said pixelated light beam, located at the level of the target object; and

c. progressively modifying at least one first pixel of the second pixelated light beam when the target object moves from said given zone toward the other zone of the first and second predetermined emission zones and before the target object reaches the other zone.

Thus, it is understood that, by virtue of the invention, when the target object moves from the given zone in order to enter the other zone, the one or more pixels of the lower resolution light beam have already been attenuated, even turned off, or on the contrary, enhanced, or even turned on again. Therefore, the eye of the driver of the host vehicle has already been accustomed, and the transition when lighting or extinguishing this or these pixels of the lower resolution light beam occurs smoothly, without hindering the driver.

According to the invention, the first and second pixelated beams are emitted simultaneously and together produce an anti-dazzle high beam lighting function for said target object. Advantageously, the light intensity of each of the pixels of each pixelated beam is selectively controllable, for example, as a function of information received from a sensor of the host vehicle. For example, extinguishing a pixel corresponds to setting its light intensity to a zero value, attenuating a pixel corresponds to reducing its light intensity to a non-zero value below its current value, relighting a pixel corresponds to setting its light intensity to a predetermined maximum value, and enhancing a pixel corresponds to increasing its light intensity to a value below said maximum value and above its current value.

The resolution of a pixelated light beam is understood to be the number of pixels included in said pixelated beam, in particular with respect to the surface of the emission zone in which the pixelated light beam is emitted, with the pixelated beam thus being made up of a plurality of pixels arranged as a plurality of rows and/or columns, and with this resolution particularly being a function of the dimensions of each pixel and of the dimension of the emission zone associated with this beam. Advantageously, the vertical resolution of the first pixelated beam, namely the number of rows forming this first pixelated beam, is greater than the vertical resolution of the second pixelated beam, with their horizontal resolutions, namely the number of columns forming them, being able to be identical or different. Adjacent emission zones are understood to be two emission zones juxtaposed with each other so that at least one pixel of one of the pixelated beams located at the edge of the associated emission zone is in contact with at least one pixel of the other pixelated beam located at the edge of the associated emission zone. If applicable, said first pixel of the second pixelated beam is a pixel located at the edge of the second emission zone and in contact with at least one pixel of the first pixelated beam located at the edge of the first emission zone.

Advantageously, the step of detecting the target object involves determining the position of the target object, and optionally its speed. Advantageously, the dark zone is centered at the level of the position of the target object. If applicable, the step of progressively modifying said at least one first pixel can be implemented as a function of the development of said position, and optionally of said speed.

Advantageously, the method comprises an additional step, on completion of the step of progressive modification, of removing said dark zone in the pixelated light beam associated with said given zone and of forming a dark zone in the pixelated light beam associated with the other zone, by extinguishing or attenuating at least one pixel of this pixelated light beam located at the level of the target object. It is understood that the invention thus encapsulates two types of transitions of the target object, namely a transition of the target object from the first emission zone toward the second emission zone and a transition of the target object from the second zone toward the first zone. According to the first type of transition, the first emission zone is the given zone, and the progressive modification of said at least one first pixel of the second beam is implemented by progressively attenuating the light intensity of this pixel before the target object reaches the second emission zone, in particular at the level of this first pixel. On completion of this progressive modification, when the target object reaches the second zone, this first pixel is extinguished or sufficiently attenuated in order to form a dark zone in the second pixelated light beam, and the pixels of the first pixelated light beam forming said dark zone in the first pixelated light beam can be turned on again or enhanced. According to the second type of transition, the second emission zone is the given zone, and the progressive modification of said at least one first pixel of the second beam is implemented by progressively enhancing the light intensity of this pixel before the target object reaches the first emission zone, in particular to the right of this first pixel. On completion of this progressive modification, when the target object reaches the first zone, this first pixel is turned on again or is sufficiently enhanced to remove said dark zone in the second pixelated light beam, and one or more pixels of the first pixelated light beam can be extinguished or attenuated in order to form a dark zone in the first pixelated beam.

In one embodiment of the invention, the step of progressive modification comprises the following steps:

a. defining an attenuation mask, the attenuation mask moving concomitantly with the target object; and

b. modifying said first pixel of the second pixelated light beam when a cell of the attenuation mask is adjacent to this first pixel.

An attenuation mask is understood to be a panel comprising a plurality of cells disposed as a plurality of rows and/or columns. This attenuation mask is virtually overlaid on the pixelated beams, for example, by being centered on the position of the target object, so as to be able to modify the light intensity of said at least one first pixel of the second light beam as a function of the position of said attenuation mask when it moves concomitantly with the target object. Depending on the position of the target object, the attenuation mask can be located at the level of the first pixelated beam only, at the level of the second pixelated beam only or simultaneously at the level of the two pixelated beams. According to the invention, said first pixel comprises two lateral edges, namely a first and a second edge in the direction of travel of the target object, and therefore of the attenuation mask. A cell of the attenuation mask adjacent to a pixel is thus understood, for example, to be a cell that is in contact with the first edge of the first pixel in this direction of travel. The attenuation mask moves concomitantly with the target object, several cells can be successively adjacent to the first pixel when the attenuation mask moves, so that, for each new cell adjacent to the first pixel, the light intensity of the first pixel is modified in order to implement the progressive modification of this light intensity.

Advantageously, the values of the cells of the attenuation mask define an attenuation gradient. If applicable, said first pixel is modified in accordance with the value of said cell adjacent to this first pixel. For example, the value of each cell can define an attenuation coefficient, with the light intensity of the first pixel being modified in order to assume the value of its maximum intensity multiplied by the attenuation coefficient of the cell adjacent to the first pixel.

According to one embodiment of the invention, the gradient defined by the values of cells can be a symmetrical horizontal gradient, the minimum of which is located at the level of the center of the attenuation mask. This type of gradient ensures a smooth transition, whether this involves a transition from the first emission zone toward the second emission zone, or vice versa. As an alternative embodiment, the gradient can be an asymmetrical horizontal gradient, the minimum of which is located at the level of an edge of the attenuation mask. Indeed, the intention may be for only a single type of transition to be smooth, for example, from the first emission zone toward the second emission zone.

Advantageously, the horizontal dimension of the attenuation mask is greater than or equal to the width of the target object. The horizontal dimension is understood to be the number of columns forming the attenuation mask. This feature ensures that the progressive modification of the first pixel will occur before the target object reaches the other zone. Advantageously, the width of the target object can be a measured width, for example, when the target object is a target motor vehicle, by detecting the position of the headlights of this target vehicle and by determining the gap separating these two headlights. As an alternative embodiment, the width of the target object can be a predetermined value.

Advantageously, the vertical resolution of the attenuation mask is substantially identical to that of the second pixelated beam. In other words, the number of rows and the vertical dimension of each of the rows of the attenuation mask respectively correspond to the number of rows and to the vertical dimension of each of the rows of pixels of the second pixelated beam.

According to one embodiment of the invention, the dark zone, when it is formed in the first pixelated light beam, is produced by attenuating a predetermined number of pixels in a zone centered on the target object. This attenuation is implemented, for example, by means of a blur mask centered at the level of the position of the target object and exclusively applied to the pixels of the first pixelated light beam. If applicable, the blur mask can comprise a plurality of cells, the dimensions of which correspond to the dimensions of the pixels of the first pixelated light beam, and the values of which define, for example, a radial gradient, the minimum of which is located at the center of the mask disposed at the level of the position of the target object. This blur mask particularly allows the movement of the dark zone within the first pixelated light beam to be attenuated when the target object moves.

Advantageously, the horizontal resolution of the attenuation mask is determined as a function of the number of values adopted by the pixels of the dark zone of the first pixelated light beam. For example, the radial gradient of the blur mask can define a given number of light intensity values likely to be adopted by the pixels of the first pixelated light beam. If applicable, the number of columns of the attenuation mask can be greater than or equal to twice this number of values. Advantageously, the horizontal dimension of the columns of the attenuation mask can correspond to the horizontal dimension of the pixels of the first pixelated light beam. This thus ensures that the transition of the dark zone from the first zone toward the second emission zone will occur consistently with the transition of the dark zone within the first emission zone alone.

Advantageously, the method comprises the following step, when said given zone is the second predetermined zone: progressively modifying at least one second pixel of the second pixelated light beam when the target object moves from the first pixel toward said second pixel and before the target object reaches the second pixel. This feature enables the smooth transition of the dark zone within the second emission zone alone.

In another embodiment of the invention, the step of progressive modification comprises a step of predicting a movement trajectory of the target object from the given zone toward the other emission zone and a step of modifying the first pixel as a function of said predicted trajectory. If applicable, the intensity of the first pixel can be modified along a determined curve, for example, a ramp, particularly as a function of the speed of movement of the target object along the predicted trajectory.

According to one embodiment of the invention, the first pixelated light beam is a light beam comprising a plurality of pixels, for example, 500 pixels with dimensions ranging between 0.05° and 0.2°, distributed over a plurality of rows and columns, for example, 20 rows and 25 columns, and wherein the second pixelated light beam is a light beam comprising a plurality of pixels, for example, 10 pixels with dimensions of more than 1°, distributed over a single row. For example, each light module comprises a plurality of light sources and an optical device arranged to together emit a pixelated light beam, as well as a controller that selectively controls each of the light sources of the light module so that this light source emits an elementary light beam forming one of the pixels of the pixelated light beam. A light source is understood to mean any light source optionally associated with an electro-optical element, capable of being selectively activated and controlled so as to emit an elementary light beam, the light intensity of which is controllable. This could particularly involve a light-emitting semiconductor chip, a light-emitting element of a monolithic pixelated light-emitting diode, a portion of a light-converting element able to be excited by a light source, or even a light source associated with a liquid crystal or with a micromirror.

A further aim of the invention is a computer program comprising a program code that is designed to implement the method according to the invention.

A further aim of the invention is a data medium, on which the computer program according to the invention is recorded.

### BRIEF DESCRIPTION OF THE DRAWINGS

The present invention will now be described with reference to examples that are only illustrative and in no way limit the scope of the invention, and with reference to the accompanying illustrations, in which:

FIG. 1 schematically and partially shows a lighting device for implementing a method according to one embodiment of the invention;

FIG. 2 schematically shows a projection on a screen of the light beams emitted by the lighting device of FIG. 1;

FIG. 3 shows a method for controlling the lighting device of FIG. 1 according to one embodiment of the invention;

FIG. 4 schematically shows a projection on a screen of the pixelated beams emitted by the device of FIG. 1 at a given instant of the implementation of the method of FIG. 3;

FIG. 5 schematically shows a projection on a screen of the pixelated beams emitted by the device of FIG. 1 at another given instant of the implementation of the method of FIG. 3;

FIG. 6 schematically shows a projection on a screen of the pixelated beams emitted by the device of FIG. 1 at another given instant of the implementation of the method of FIG. 3;

FIG. 7 schematically shows a projection on a screen of the pixelated beams emitted by the device of FIG. 1 at another given instant of the implementation of the method of FIG. 3;

FIG. 8 shows an example of a blur mask used in the method of FIG. 3; and

FIG. 9 shows an example of an attenuation mask used in the method of FIG. 3.

### DETAILED DESCRIPTION OF THE INVENTION

In the following description, elements that are identical in terms of structure or in terms of function and that appear across various figures use the same reference signs, unless otherwise indicated.

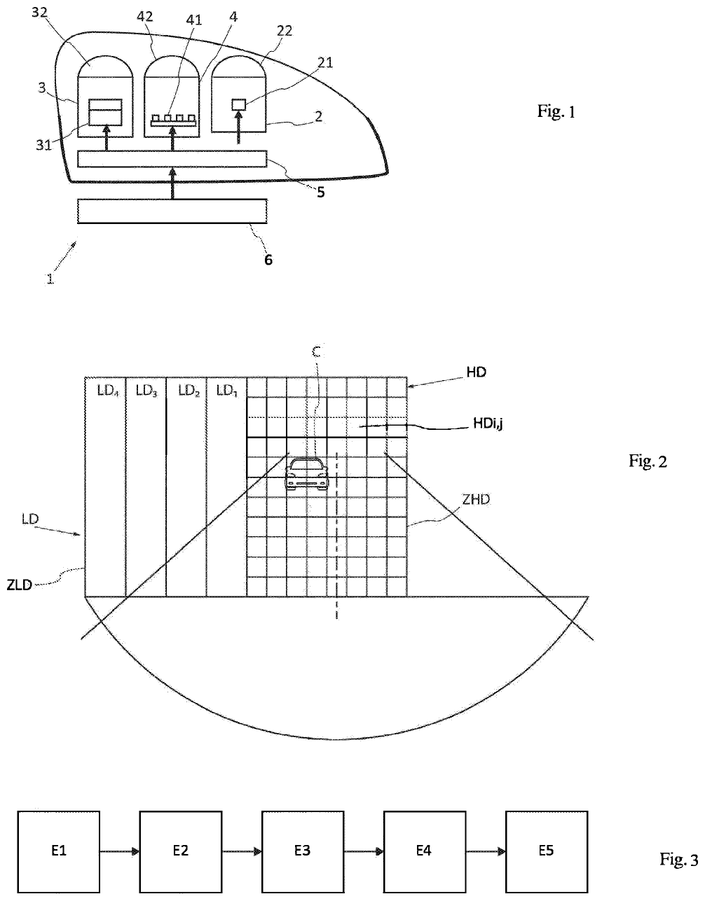

FIG. 1 shows a right-hand side lighting device 1 of a host motor vehicle, comprising three light modules 2, 3 and 4. The light module 2 comprises a light source 21 associated with a lens 22 for emitting a light beam of the low beam LB type. The light module 3 comprises a pixelated light source 31 associated with a lens 32 for emitting a first pixelated light beam HD and the light module 4 comprises a matrix of LEDs 41 associated with a lens 42 for emitting a second pixelated beam LD. In the example described, the pixelated light source 31 is a monolithic pixelated light-emitting diode, each of the light-emitting elements of which forms a light source that is able to be selectively activated and controlled by an integrated controller in order to emit an elementary light beam, the light intensity of which is able to be controlled, and thus forming one of the pixels of the pixelated light beam HD. The lighting device 1 comprises a controller 5 arranged to control the light source 21, the controller integrates the pixelated light source 31 and the LEDs of the matrix of LEDs 41 so as to selectively control the illumination, the extinction and the modification of the light intensity of each of the pixels of the pixelated light beams HD and LD, as well as the illumination or the extinction of the beam LB, as a function of information received from a computer 6 of the host vehicle, in order to implement an anti-dazzle high beam lighting function. These light beams LB, HD and LD are shown in FIG. 2 projected onto a screen when they are emitted simultaneously.

In the example described, the first pixelated light beam HD is emitted in a first emission zone ZHD and comprises 88 pixels HDi,j of dimensions 0.2°, distributed over 8 columns and 11 rows. The second pixelated light beam LD is emitted in a second emission zone ZLD and comprises 4 pixels LDi of dimensions 1°, distributed over a single row. As shown in FIG. 2, the resolution of the first pixelated beam HD, and in particular its vertical resolution, is therefore higher than the resolution of the second pixelated beam LD. Furthermore, the first emission zone ZHD is adjacent to the second emission zone ZLD. Indeed, the pixels HD1,1 to HD1,11 of the first pixelated light beam HD located at the edge of the first emission zone ZHD and on the side of the second emission zone ZLD are juxtaposed and in contact with the first pixel LD1 of the second pixelated light beam LD located at the edge of the second emission zone ZLD and on the side of the first emission zone ZHD. Finally, the emission zones ZLD and ZHD extend above an upper cut-off line of the low beam LB so as to cover a road scene on which a target motor vehicle C is travelling. The first emission zone ZHD thus extends over a central portion of the road scene, whereas the second zone ZLD extends over a lateral portion of the road scene. The embodiment described in FIG. 2 does not mention a pixelated light beam on the other side of the first pixelated beam HD, but such a beam could be provided symmetrical to the second pixelated beam LD without departing from the scope of the present invention.

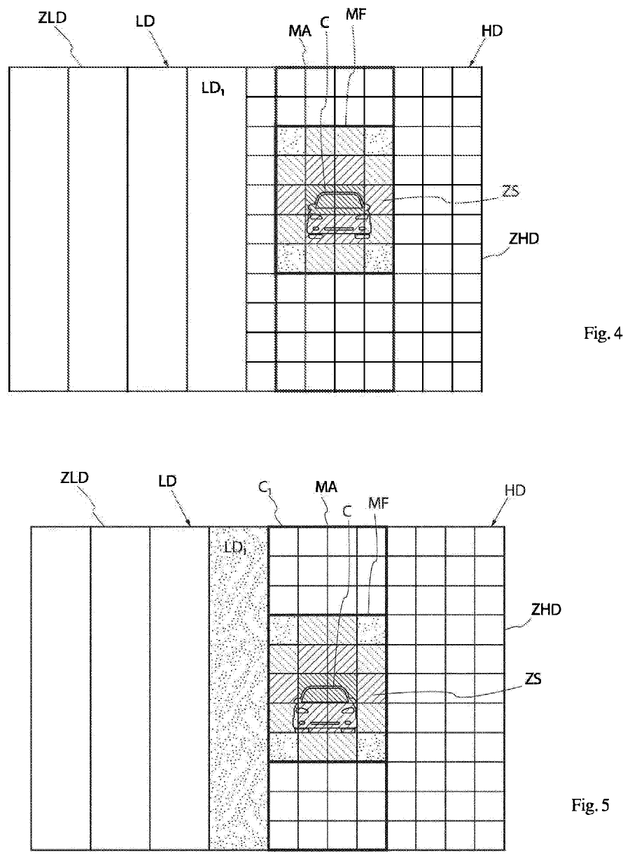

A method for controlling the lighting device 1 according to one embodiment of the invention, implementing an anti-dazzle high beam lighting function, is shown in FIG. 3, and the various stages of which will now be described with reference to FIG. 4 to FIG. 7, which show the pixelated light beams HD and LD projected onto a screen during these various steps.

The control method comprises a first step E1 of detecting the presence of the target vehicle C and of determining the position of the target object C on the road. This step E1 can be implemented, for example, by one or more sensors of the host vehicle, such as, for example, a camera and/or a radar and/or a lidar, associated with the computer 6 of the host vehicle implementing image or signal processing algorithms. On completion of step E1, the computer 6 notifies the controller 5 of the presence of the target object C and provides its position.

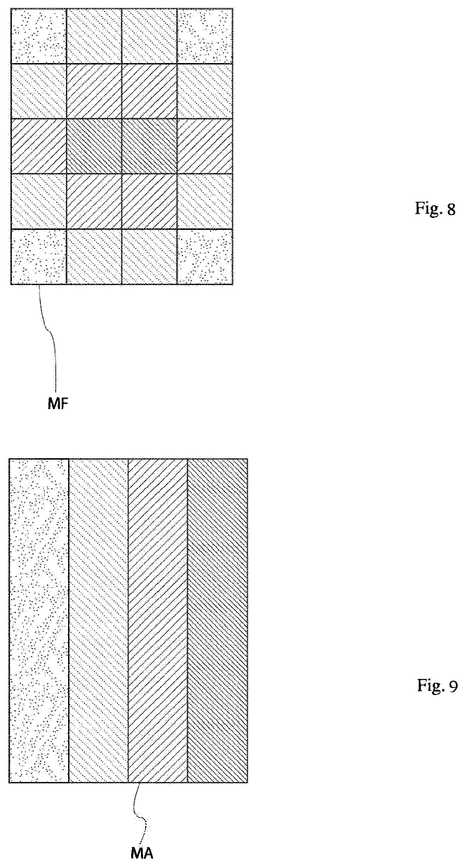

The method comprises a second step E2 of forming a dark zone ZS in one and/or the other of the pixelated beams HD and LD as a function of said position of the target object C. In the example described, the target object C is located in the first emission zone ZHD associated with the first pixelated beam HD. The controller 5 will thus initially define a blur mask MF comprising 20 cells divided into 4 columns and 5 rows and the dimensions of which correspond to the pixels HDi,j of the first pixelated beam HD and the values of which define a radial gradient, the minimum of which is located at the center of the mask MF. An example of a blur mask MF is shown in FIG. 8. The radial gradient of this example of a blur mask MF defines 4 values that can be adopted by the pixels HDi,j of the first pixelated beam, namely 0%, 25%, 50%, 75% of a maximum intensity value that can be adopted by these pixels, with the 0% values being located at the center of the mask and the 75% values being located at the corners of the mask. These values have been shown in FIG. 8 using various distributions of dotted lines.

Secondly, the controller 5 will apply the blur mask MD to the pixels HDi,j of the first pixelated beam HD by centering the blur mask MD on the position of the target object C. Each affected pixel HDi,j thus will be switched off or attenuated, so that its light intensity corresponds to the value of the corresponding cell of the blur mask MF, with the other unaffected pixels HDi,j being kept on, so as to form the dark zone ZS. All the pixels LDi are also kept on. The beam resulting from the combination of the beams HD and LD therefore illuminates the road ahead of the host vehicle as much as possible, without dazzling the driver of the target vehicle C.

During a third step E3, the controller 5 will also define an attenuation mask MA and overlay this attenuation mask MA with the position of the target object C. The attenuation mask MA comprises 44 cells divided into as many rows as the second pixelated beam LD comprises, in this case a single row with the same dimensions as those of the rows of the second pixelated beam LD, and into as many columns as the number of values defined by the gradient of the blur mask, in this case four columns with the same dimensions as those of the columns of the first pixelated beam HD. The values of the cells of the attenuation mask MA define an asymmetrical horizontal gradient, the minimum of which is located at an edge of the mask MA. An example of an attenuation mask MA is shown in FIG. 9.

As will be described hereafter, during a step E4, the controller 5 will modify the value of at least the first pixel LD1 of the second pixelated beam LD as a function of the position of this attenuation mask MA with respect to the second emission zone ZLD. Indeed, the attenuation mask MA is centered on the position of the target vehicle C and moves concomitantly therewith. The first pixel LD1 thus will be modified by the controller 5 when a cell of the attenuation mask MA is adjacent to this first pixel LD1.

At the time of FIG. 4, the attenuation mask MA is remote from the first pixel LD1. Therefore, there is no need to change the intensity of this first pixel LD1.

At the time of FIG. 5, the target vehicle C has moved along the road scene in order to approach and pass the host vehicle. The blur mask MF has also moved in order to remain centered on the position of the target vehicle C, so that the dark zone ZS remains at the level of the target vehicle C to avoid dazzling said vehicle. At this time, the target vehicle C nevertheless has not reached the second emission zone ZLD. However, a cell C1 of the attenuation mask MA is now adjacent to the first pixel LD1 of the second pixelated beam LD. The controller 5 will thus modify the light intensity of the first pixel LD1 so that this light intensity corresponds to the value of the cell C1. Thus, it can be seen that the first pixel LD1 attenuates before the target vehicle C has reached the second emission zone ZLD.

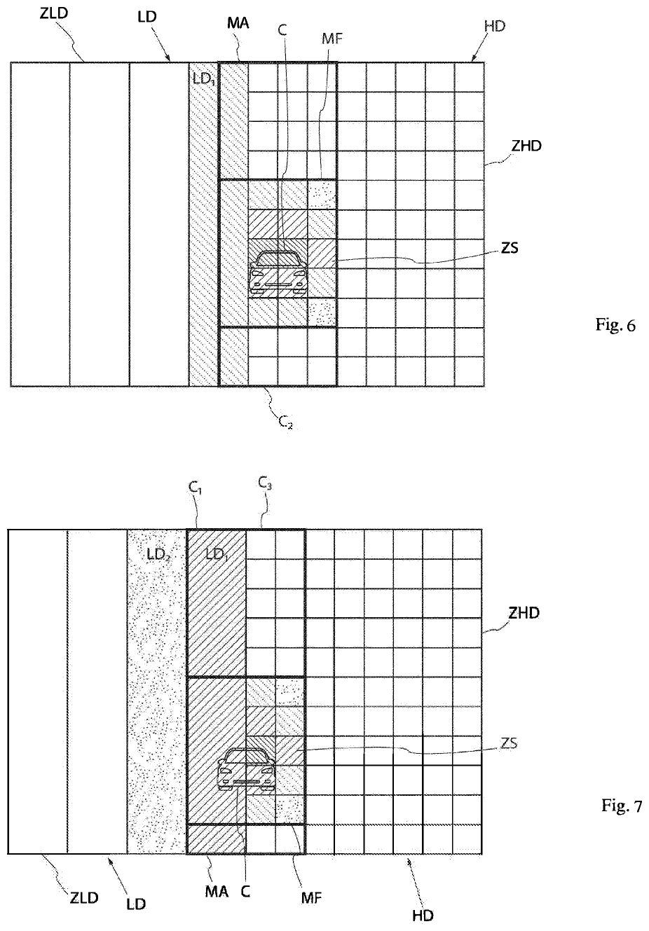

At the time of FIG. 6, the target vehicle C has still moved along the road scene toward the host vehicle, yet without reaching the second emission zone ZLD. The blur mask MF thus has moved in order to follow the position of the target vehicle, and has reached the edge of the first emission zone ZHD. A smaller number of pixels of the first pixelated beam HD was thus affected by the mask MF in order to define the dark zone ZS. Furthermore, a second cell C2 of the attenuation mask MA is now adjacent to the first pixel LD1 of the second pixelated beam LD, which implies that the controller 5 will again modify the light intensity of this first pixel LD1 according to the value of this second cell C2. Due to the horizontal gradient defined by the attenuation mask MA, the attenuation of the first pixel LD1 is higher, despite the fact that the target vehicle C still has not reached the second emission zone ZLD.

At the time of FIG. 7, the target vehicle C has moved and has reached the second emission zone ZLD. The light intensity of the first pixel LD1 is thus again attenuated by the controller 5 according to the value of the cell C3 of the attenuation mask MA adjacent thereto, whereas the number of pixels HDi,j switched off or attenuated in order to form the dark zone ZS in the first pixelated light beam HD continues to decrease. Furthermore, the cell C1 of the attenuation mask MA is now adjacent to the second pixel LD2 of the second pixelated beam LD, so that the controller 5 also attenuates the light intensity of this second pixel according to the value of the cell C1.

Thus, it is understood that the pixel LD1 thus experiences progressive attenuation of its light intensity when the target vehicle C transitions from the first emission zone ZHD toward the second emission zone ZLD. This transition will conclude in a step E5, not shown, with the removal of the dark zone ZS in the first pixelated beam HD, with all the pixels HDi,j being illuminated, and with the complete extinction of the pixel LD1 of the second pixelated beam LD in order to form a dark zone in this second pixelated beam at the level of the target vehicle C. Furthermore, the light intensity of the second pixel LD2 will be progressively attenuated in order to prepare for the transition of the target vehicle C from the first pixel LD1 toward the second pixel LD2.

The description of the method according to this embodiment was provided for a transition of the target vehicle C from the first emission zone ZHD toward the second emission zone ZLD. It is obvious that this method can be applied in the same manner for a transition of the target vehicle C from the second emission zone ZLD toward the first emission zone ZHD, for example, when the target vehicle C is a followed vehicle or a vehicle performing an overtaking maneuver, by enhancing the light intensity of the first pixel LD1 before the target vehicle has reached the first emission zone ZHD.

The above description clearly explains how the invention allows its stated objectives to be achieved, and in particular by proposing a method for controlling a hybrid lighting device emitting two pixelated light beams with different resolutions, which, by progressively modifying a pixel of one of the pixelated light beams before a target object has reached the emission zone of this beam, enables a dark zone located at the level of the target object to smoothly transition from the other one of the beams toward this beam.

In any event, the invention should not be regarded as being limited to the embodiments specifically described in this document, and in particular it extends to any equivalent means and any technically operative combination of these means. In particular, other types of attenuation mask can be contemplated by varying its dimensions or the values of its cells. The use of an attenuation mask without a blur mask also can be contemplated. Finally, other embodiments of a progressive transition can be contemplated that implement, for example, a prediction of the trajectory of the target vehicle and a progressive modification of the intensity of the first pixel of the second pixelated light beam as a function of said predicted trajectory.

What is claimed is:

1. A method for controlling a device for a motor vehicle comprising at least first and second light modules arranged to respectively emit first and second pixelated light beams in first and second predetermined emission zones that are associated with them, the resolution of the first pixelated light beam being greater than the resolution of the second pixelated light beam and the first and second predetermined emission zones being adjacent, the method comprising:
detecting the presence of a target object in a given zone from among the first and second predetermined emission zones;
forming a dark zone in the pixelated light beam associated with the given zone, by extinguishing or attenuating at least one pixel of the first pixelated light beam, located at the level of the target object;
progressively modifying at least one first pixel of the second pixelated light beam when the target object moves from the given zone toward an other zone of the first and second predetermined emission zones and before the target object reaches the other zone.

2. The method as claimed in claim 1, wherein the step of progressive modification includes
defining an attenuation mask, the attenuation mask moving concomitantly with the target object, and
modifying the first pixel of the second pixelated light beam when a cell of the attenuation mask is adjacent to this first pixel.

3. The method as claimed in claim 2, wherein the values of the cells of the attenuation mask define an attenuation gradient, and wherein the first pixel is modified in accordance with the value of the cell adjacent to this first pixel.

4. The method as claimed in claim 3, wherein the gradient defined by the values of the cells is a symmetrical horizontal gradient, the minimum of which is located at the center of the attenuation mask.

5. The method as claimed in claim 2, wherein the horizontal dimension of the attenuation mask is greater than or equal to the width of the target object.

6. The method as claimed in claim 2, wherein the vertical resolution of the attenuation mask is substantially identical to that of the second pixelated beam.

7. The method as claimed in claim 1, wherein the dark zone, when it is formed in the first pixelated light beam, is produced by attenuating a predetermined number of pixels in a zone centered on the target object.

8. The method as claimed in claim 2, wherein the horizontal resolution of the attenuation mask is determined as a function of the number of values adopted by the pixels of the dark zone of the first pixelated light beam.

9. The method as claimed in claim 1, further comprising
progressively modifying at least one second pixel of the second pixelated light beam when the target object moves from the first pixel toward said a second pixel and before the target object reaches the second pixel, when the given zone is the second predetermined zone.

10. The method as claimed in claim 1, wherein the first pixelated light beam is a light beam comprising a plurality of pixels distributed over a plurality of rows and columns and wherein the second pixelated light beam is a light beam comprising a plurality of pixels distributed over a single row.

11. A computer program comprising a program code that is designed to implement the method as claimed in claim 1.

12. A data medium, on which the computer program as claimed in claim 11 is recorded.
